(19) United States
(12) Patent Application Publication
(10) Pub. No.: US 2024/0270951 A1
(43) Pub. Date: Aug. 15, 2024

(54) HIGH CLARITY AND DUCTILE MOLDING COMPOSITION COMPRISING A SMMA COPOLYMER AND A SBC-BLOCK COPOLYMER

(71) Applicant: INEOS STYROLUTION GROUP GMBH, Frankfurt am Main (DE)

(72) Inventors: Thomas W. COCHRAN, Wilmington, IL (US); Jarrett R. ROWLETT, Oswego, IL (US)

(21) Appl. No.: 18/569,507

(22) PCT Filed: Jun. 14, 2022
(86) PCT No.: PCT/EP2022/066170

§ 371 Date: Dec. 12, 2023

(30) Foreign Application Priority Data
Jun. 16, 2021 (EP) 21179715.4

(51) Int. Cl. C08L 25/14

(52) U.S. Cl. CPC C08L 25/14

(57) ABSTRACT

High clarity and ductile molding composition comprising: (a) 71 to 90 wt.-% random copolymer made from 44 to 64 wt.-% vinylaromatic monomer and 36 to 56 wt.-%, methyl methacrylate; (b) 10 to 29 wt vinylaromatic-diene block copolymer comprising at least two hard blocks S made from vinylaromatic monomers and at least one soft block B made from dienes and/or at least one soft block B/S made from dienes and vinylaromatic monomers; where the proportion of the diene is from 47 to 67 wt.-%; and (c) 0 to 5 wt.-% additives and/or processing aids (c), have high hardness, heat resistance, and stiffness and can be used for home appliances.

The invention relates to a molding composition comprising a styrene-methyl methacrylate (SMMA) copolymer and a styrene-butadiene (SBC) block copolymer. These (thermoplastic) molding compositions and products therefrom have high clarity, hardness, heat resistance, and stiffness. The invention also relates to a process for the preparation method and to thermoplastic molding compositions and shaped articles produced therefrom and to their use.

Styrene-butadiene block copolymers are known for years to provide effective modifiers to gain impact strength in blends with styrene-methyl methacrylate copolymers while still maintaining a good transparency and/or low haze.

U.S. Pat. Nos. 5,290,862 and 6,734,247 describe blends of SMMA copolymers (MMA 25 to 35 wt.-%) and SBC with the SBC having a tapered, linear or radial, di-block (vinyl aromatic monomer-conjugated diene) or tri-block (vinyl aromatic monomer-conjugated diene-vinyl aromatic monomer) molecular architecture. The optical properties such as clarity and haze as well as the mechanical properties such as toughness (Notched Izod Impact strength) of the obtained materials are still in need of improvement.

WO 2018/091513 discloses a polymer composition comprising 48 to 67 wt.-% of a SMMA copolymer (MMA content: 10 to 35 wt.-%) and 33 to 52 wt.-% of a star-shaped vinylaromatic diene block copolymer (diene content: 15 to 50 wt.-%) comprising at least two terminal vinyl-aromatic polymer blocks S₁ and S₂ and at least one random vinyl-aromatic/diene copolymer block (B/S). Said compositions show an improved toughness and clarity. However, the heat resistance and the scratch resistance (i.e. surface hardness) of said prior art compositions are still in need of improvement.

It is an object of the invention to provide a molding composition comprising SMMA copolymers and SBC block copolymers with a good balance of stiffness and toughness, with a high surface hardness and Vicat softening temperature while maintaining a high transmittance and clarity. It is a further object of the invention to provide a SMMA/SBC-molding composition having an improved processability (i.e. in an extrusion process).

According to the invention, this object is achieved by providing a molding composition according to the claims.

One aspect of the invention is a molding composition comprising (or consisting of) the components (a), (b) and (c):
(a) 71 to 90 wt.-% of at least one random copolymer (a) made from 44 to 64 wt.-%, preferably 48 to 60 wt.-%, more preferably 50 to 58 wt.-%, vinylaromatic monomer (a11), in particular styrene, and 36 to 56 wt.-%, preferably 40 to 52 wt.-%, more preferably 42 to 50 wt.-%, methyl methacrylate (a12);
(b) 10 to 29 wt.-% of at least one vinylaromatic-diene block copolymer (b) which comprises at least two hard blocks S (preferably terminal S blocks) made from vinylaromatic monomers, in particular styrene, and at least one soft block B made from dienes and/or at least one soft block B/S made from dienes and vinylaromatic monomers,
   where the proportion of the diene—based on the entire block copolymer—is from 47 to 67 wt.-%, preferably 52 to 62 wt.-%; and
(c) 0 to 5 wt.-% of one or more additive(s) and/or processing aid(s) (c),
wherein the total amount of components (a), (b) and (c) is 100 wt.-%.

In this document, wt.-% means percent by weight.

A random copolymer (a) means a copolymer having a statistical distribution of the polymerized units of the vinylaromatic monomer and methyl methacrylate.

Preferably the molding composition according to the invention comprises (or consists of) components (a), (b) and (c) in the following amounts:
(a) 75 to 88 wt.-%,
(b) 12 to 25 wt.-%,
(c) 0 to 5 wt.-%.

More preferably the molding composition according to the invention comprises (or consists of) components (a), (b) and (c) in the following amounts:
(a) 78 to 85 wt.-%,
(b) 15 to 22 wt.-%,
(c) 0 to 3 wt.-%.

In particular preferred is a molding composition according to the invention comprising or (consisting of):
(a) 73 to 80 wt.-%.
(b) 17 to 20 wt.-%,
(c) 0 to 3 wt.-%.

If component (c) is present, its minimum amount is usually 0.1 wt.-%.

Preferred are molding compositions according to the invention wherein component (a) forms a continuous phase in which component (b) is finely dispersed.

Preferred are molding compositions wherein the values of the refractive index of components (a) and (b) differ no more than 0.01, preferably 0.005, more preferably 0.003. This results in a product of particular high clarity and low haze.

In one preferred embodiment, the molding composition according to the invention consists of the components (a), (b) and optionally (c).

### Component (a)

Preferred are random copolymers (a)—as component (a)—made from 48 to 60 wt.-% vinylaromatic monomer (a11), in particular styrene, and 40 to 52 wt.-% methyl methacrylate (a12); more preferred are random copolymers (a) made from 50 to 58 wt.-% (a11) and 42 to 50 wt.-% (a12). In said compositions the total amount of (a11) and (a12) is 100 wt.-%.

Styrene-methyl methacrylate (SMMA) copolymers (a) may be obtained in a known manner by bulk, solution, suspension, precipitation or emulsion polymerization. Details of these processes are described, for example, in Kunststoffhandbuch, ed. R. Vieweg and G. Daumiller, Vol. V “Polystyrol”, Carl-Hanser-Verlag Munich, 1969, p. 118 ff. SMMA copolymers (a) are known products which are commercially available e.g. from Ineos Styrolution (Frankfurt, Germany) as NAS® XC.

### Component (b)

The at least one, preferably one, vinylaromatic-diene block copolymer (b)—as component (b)—may be a linear or star-shaped block copolymer and comprises at least two hard blocks S (preferably terminal blocks) made from vinylaromatic monomers, in particular styrene, and at least one soft block B made from dienes and/or at least one soft block B/S made from dienes and vinylaromatic monomers.

Generally—based on the entire block copolymer—the proportion of the diene is from 47 to 67 wt.-%, and the proportion of the vinylaromatic monomer is from 33 to 53 wt.-%.

Preferably—based on the entire block copolymer—the proportion of the diene is from 52 to 62 wt.-%, and the proportion of the vinylaromatic monomer is from 38 to 48 wt.-%. Vinyl aromatic monomers which may be used for the hard (polymer) blocks S or else for the soft (copolymer) block B/S are styrene, α-methylstyrene, p-methylstyrene, ethylstyrene, tert-butylstyrene, vinyl toluene or mixtures of these, preferably styrene. The hard (polymer) blocks S of the block copolymer (b) are hard phases with a glass transition temperature (Tg)>70° C.

The hard blocks S can be made from 95 to 100 wt.-% of at least one vinylaromatic monomer and 0 to 5 wt.-% of at least one diene, preferably the hard blocks S are homopolymers made from vinylaromatic monomers, in particular styrene.

Suitable dienes which may be used for the preparation of component (b) are conjugated dienes. Preferred dienes for the at least one soft block B or the at least one soft block B/S (or optionally for the hard blocks S) are 1,3-butadiene, isoprene, 2,3-dimethylbutadiene, 1,3-pentadiene, 1,3-hexadienes or piperylene or mixtures of these, particularly preferably 1,3-butadiene. The soft (polymer) block B and/or soft (copolymer) block B/S is a soft phase with a Tg<0° C.

The soft block B may be made from 95 to 100 wt.-% of at least one diene and 0 to 5 wt. % of at least one vinylaromatic monomer, preferably the soft block B is a homopolymer made from a conjugated diene, in particular 1,3-butadiene.

Often the soft block is a block B/S, in particular a random block B/S. A “random” block B/S means a copolymer block having a statistical distribution of the polymerized units of the vinylaromatic monomers and dienes.

Often the (copolymer) block B/S, in particular the random copolymer block B/S, is made from more than 5 to 39 wt.-%, in particular 6 to 39 wt.-%, vinylaromatic monomer, in particular styrene, and from 61 to less than 95 wt.-%, in particular 61 to 94 wt.-%, diene, in particular 1,3-butadiene, wherein the total amount of the vinyl aromatic monomer and the diene is 100 wt.-%.

Preferably block copolymer (b) is a linear block copolymer with two hard blocks S, preferably terminal hard blocks S, and, at least one soft block B and/or at least one soft block B/S.

There may also be more than one, preferably random, (copolymer) block B/S. Often block copolymer (b) comprises at least 2, in particular random, soft (copolymer) blocks (B/S)₁ and (B/S)₂ having different proportions of vinylaromatic monomers and therefore different glass transition temperatures. For all copolymer blocks B/S such as (B/S)₁, (B/S)₂ etc, Tg is <0° C., generally in the range between −80° to 0° C., preferably in the range from −70° C. to −20° C., particularly preferably from −70 to −40° C. Tg is measured by methods known to the SBC-polymer chemist.

According to one embodiment block copolymer (b) is a block copolymer of the structure S-B-S, in particular a styrene-butadiene block copolymer of the structure S-B-S.

According to an embodiment block copolymer (b) is a block copolymer of the structure S-B/S-S, in particular a styrene-butadiene block copolymer of the structure S-B/S-S.

The block copolymers (b) are prepared preferably by sequential anionic polymerization. The aforementioned SBC products are known. Their preparation is described in “Modern Styrenic Polymers: Polystyrenes and Styrenic Copolymers” (Eds., J. Scheirs, Wiley, U K, 2003, pages 502 to 507), in Practical Guide to Structures, Properties and Applications of Styrenic Polymers; N. Niessner et al., Smithers, 2013, pp. 79-129) and in U.S. Pat. No. 6,521,712 (col. 2, I. 52 to col. 4, line 2). Block copolymer (b) is a known product and commercially available as Calprene® 743X from Dynasol, USA.

### Component (c)

Optionally the thermoplastic molding composition may comprise up to 5.0 wt.-%, preferably 0.10 to 3.0 wt.-%, of at least one further additive and/or processing aids (c) (as component (c)).

Suitable additives and/or processing aids (c) include all substances customarily employed for processing or finishing the polymers, except of fillers/fibers and pigments (see e.g. “Plastics Additives Handbook”, Hans Zweifel, 6th edition, Hanser Publ., Munich, 2009).

Preferred additives and/or processing aids (c) are such as stabilizers (e.g. UV-stabilizers), oxidation retarders, anti-oxidants, agents to counter thermal decomposition and decomposition due to light, lubricants and dyes.

These additives and/or processing aids (c) may be admixed at any stage of the manufacturing operation, but preferably at an early stage in order to profit early on from the stabilizing effects (or other specific effects) of the added substance.

Suitable antioxidants are, e.g., one or more compounds selected from monophosphite-based antioxidants, diphosphite-based antioxidants and sterically hindered phenolic antioxidants. If one or more antioxidants are present, they are preferably selected from monophosphite-based antioxidants, such as trisubstituted monophosphite derivatives, diphosphite-based antioxidants, such as substituted pentaerythrirol diphosphite derivatives and sterically hindered phenolic antioxidants, such as 2,6-di-tertbutylphenolic derivatives.

Suitable lubricants/glidants and demolding agents include stearic acids, stearyl alcohol, stearic esters, amide waxes (bisstearylamide, in particular ethylenebisstearamide), polyolefin waxes and/or generally higher fatty acids, derivatives thereof and corresponding fatty acid mixtures comprising 12 to 30 carbon atoms.

Suitable dyes are any of the dyes which can be used for the transparent, semitransparent, or non-transparent coloring of polymers, in particular those dyes which are suitable for coloring styrene copolymers. Dyes of this type are known to the skilled worker.

Examples of oxidation retarders and heat stabilizers are halides of the metals from group I of the periodic table, examples being sodium, potassium and/or lithium halides, optionally in combination with copper (I) halides, e.g., chlorides, bromides, iodides, sterically hindered phenols, hydroquinones, different substituted representatives of these groups, and mixtures thereof, in concentrations of up to 1 wt.-%, based on the weight of the molding composition.

Examples of suitable stabilizers to counter the effect of light (e.g UV-stabilizers) are various substituted resorcinols, salicylates, benzotriazoles, benzophenones, and HALS (hindered amine light stabilizers), for example those commercially available as Tinuvin®, which are generally used in amounts of up to 2 wt.-%, based on the molding composition.

### Process for the Preparation

A further aspect of the invention is a process for the preparation of a molding composition according to the invention by melt-mixing of components (a), (b) and, if appropriate, component (c). Preferably the melt-mixing of the components (a), (b) and, if appropriate, (c) is performed in an extruder, preferably a twin screw extruder.

The melt-mixing may be performed, preferably in an extruder, at temperatures in the range of from 160 to 260° C.

Preferably melt-mixing is performed in an extruder at temperatures in the range of from 180 to 230° C.

The molding composition obtained by said process shows a good processability and thus can be easily processed, i.e. molded to any desired shape e.g. by extrusion and hot molding (e.g. injection molding).

Accordingly a further aspect of the invention is a shaped article produced from the molding composition according to the invention.

The molding composition according to the invention and shaped articles produced therefrom show a good balance of stiffness and toughness, with a high surface hardness and Vicat softening temperature while maintaining a high transmittance and clarity. They can advantageously be used for many applications.

A further subject of the invention is the use of molding compositions according to the invention and shaped articles produced therefrom for various applications for housewares, home appliances, thermoformed packaging and blow molded bottles.

The examples, Figures and the patent claims provide further illustrate the invention.

### EXAMPLES

### Test Methods:

Tensile stress at yield and tensile strain at break were determined in the test according to norm ASTM D638-14.

Flexural modulus was determined in the test according to ASTM D790-17.

Melt flow rate (MFR) was determined according to ASTM D1238 at 200° C. and 5 kg.

Gardner impact strength was determined in accordance with ASTM D5420-21.

Notched and un-notched Izod impact strength was determined in accordance with ASTM D256-10 (2018).

Vicat softening temperature (VST) was determined according to ASTM D1525 (10 N force and 120° C./hour rate).

Rockwell hardness was determined according to ASTM D785.

Haze and optical properties (transmission, clarity) were determined in accordance with ASTM D1003.

### Starting Materials:

SMMA (a) NAS® XC from Ineos Styrolution, Germany; random styrene/methyl methacrylate-copolymer, MMA content: 45 wt.-%.
SBS (b) Calprene® 743X from Dynasol, Spain; linear styrene butadiene SBS block copolymer; total styrene content 43 wt.-%.

The materials as shown in Tables 1 to 4 were melt-mixed using a 30 mm twin screw extruder with zone temperatures set from 180 to 230° C. From the obtained molding compositions specimens were injection molded and the parts tested for their mechanical and optical properties. Tables 1 to 4 show the properties of the injection molded specimens made as a function of the block copolymer (b) content for examples 1 to 10.

Tables 1 to 4 further evidence the benefit of samples according to the invention (Examples 1 to 10) as compared to current commercial styrenic impact modified clear molding compositions such as Terlux® 2802, Terlux 2812 (both methacrylate acrylonitrile butadiene styrene (MABS) resins), Zylar® 631 (impact modified styrene acrylic copolymer (methyl methacrylate butadiene styrene (MBS) resin), Zylar 720 EX (MBS resin) and Denka TH-21 (MBS resin) used in comparative Examples 1 to 5.

Table 1, in which n/a means data not available.

| | SMMA | SBS | Flexural | Rockwell |
|---|---|---|---|---|
| | (a) | (b) | modulus | hardness |
| | wt.-% | wt.-% | (kpsi) | (R Scale) |
| Example 1 | 87.5 | 12.5 | 365 | 104 |
| Example 2 | 85 | 15 | 340 | 102 |
| Example 3 | 83.75 | 16.25 | 315 | 100 |
| Example 4 | 82.5 | 17.5 | 300 | 97 |
| Example 5 | 82 | 18 | 300 | 100 |
| Example 6 | 81.25 | 18.75 | 305 | 99 |
| Example 7 | 81 | 19 | 290 | 99 |
| Example 8 | 80 | 20 | 295 | 95 |
| Example 9 | 77.5 | 22.5 | 270 | 95 |
| Example 10 | 75 | 25 | 260 | 89 |
| Comp. Ex. 1 | n/a | n/a | 245 | 99 |
| (Terlux 2802) | | | | |
| Comp. Ex. 2 | n/a | n/a | 230 | 93 |
| (Terlux 2812) | | | | |
| Comp. Ex. 3 | n/a | n/a | 260 | 74 |
| (Zylar 631) | | | | |
| Comp. Ex. 4 | n/a | n/a | 265 | 99 |
| (Zylar 720 EX) | | | | |
| Comp. Ex. 5 | n/a | n/a | 290 | 106 |
| (Denka TH-21) | | | | |

TABLE 2

| | SMMA (a) | SBS (b) | Strain at | Stress at |
|---|---|---|---|---|
| | wt.-% | wt.-% | break (%) | yield (psi) |
| Example 1 | 87.5 | 12.5 | 10 | 6700 |
| Example 2 | 85 | 15 | 18 | 6500 |
| Example 3 | 83.75 | 16.25 | 25 | 6300 |
| Example 4 | 82.5 | 17.5 | 20 | 5600 |
| Example 5 | 82 | 18 | 22 | 5600 |
| Example 6 | 81.25 | 18.75 | 24 | 5800 |
| Example 7 | 81 | 19 | 24 | 5400 |
| Example 8 | 80 | 20 | 16 | 5500 |
| Example 9 | 77.5 | 22.5 | 23 | 5000 |
| Example 10 | 75 | 25 | 25 | 4700 |
| Comp. Ex. 1 | n/a | n/a | 29 | 5000 |
| Comp. Ex. 2 | n/a | n/a | 55 | 4500 |
| Comp. Ex. 3 | n/a | n/a | 40 | 4100 |
| Comp. Ex. 4 | n/a | n/a | 55 | 5000 |
| Comp. Ex. 5 | n/a | n/a | 40 | 5600 |

TABLE 3

| | | | | | Injection |
|---|---|---|---|---|---|
| | | | | Un- | molded |
| | SMMA | SBS | Notched | notched | Gardner |
| | (a) | (b) | Izod | Izod | impact |
| | wt.-% | wt.-% | (ft-lb/in) | (ft-lb/in) | (in-lb) |
| Example 1 | 87.5 | 12.5 | 0.4 | 3.7 | 1.7 |
| Example 2 | 85 | 15 | 0.5 | 8.7 | 1.8 |
| Example 3 | 83.75 | 16.25 | 0.5 | 13.6 | 2.5 |
| Example 4 | 82.5 | 17.5 | 0.8 | 10.6 | 5.0 |
| Example 5 | 82 | 18 | 0.5 | 13.7 | 9.7 |
| Example 6 | 81.25 | 18.75 | 0.8 | >16 (nb) | 7.3 |
| Example 7 | 81 | 19 | 0.7 | >16 (nb) | 9.3 |
| Example 8 | 80 | 20 | 0.8 | >16 (nb) | 9.1 |
| Example 9 | 77.5 | 22.5 | 0.9 | >16 (nb) | 9.1 |
| Example 10 | 75 | 25 | 0.9 | >16 (nb) | 7.9 |
| Comp. Ex. 1 | n/a | n/a | 1.0 | 15.6 | 3.3 |
| Comp. Ex. 2 | n/a | n/a | 1.3 | >16 (nb) | 3.1 |
| Comp. Ex. 3 | n/a | n/a | 2.2 | >16 (nb) | 2.8 |
| Comp. Ex. 4 | n/a | n/a | 2.1 | >16 (nb) | 182 |
| Comp. Ex. 5 | n/a | n/a | 1.5 | 13.4 | 163 |

TABLE 4

| | SMMA | SBS | MFR | | | | |
|---|---|---|---|---|---|---|---|
| | (a) | (b) | (g/10 | VST | Haze | Transmission | Clarity |
| | wt.-% | wt.-% | min) | (° C.) | (%) | (%) | (%) |
| Example 1 | 87.5 | 12.5 | 3.9 | 103.4 | 3.0 | 90.9 | 99.2 |
| Example 2 | 85 | 15 | 4.6 | 102.8 | 3.1 | 91.0 | 99.3 |
| Example 3 | 83.75 | 16.25 | 5.1 | 103.8 | 3.3 | 90.6 | 99.1 |
| Example 4 | 82.5 | 17.5 | 5.0 | 102.1 | 3.8 | 90.5 | 99.3 |
| Example 5 | 82 | 18 | 5.5 | 102.7 | 2.3 | 91.6 | 98.9 |
| Example 6 | 81.25 | 18.75 | 5.2 | 103.5 | 3.0 | 90.8 | 99.4 |
| Example 7 | 81 | 19 | 6.5 | 102.1 | 2.4 | 91.7 | 99.3 |
| Example 8 | 80 | 20 | 5.9 | 102.2 | 4.8 | 90.0 | 99.2 |
| Example 9 | 77.5 | 22.5 | 7.3 | 101.5 | 5.0 | 89.8 | 98.9 |
| Example 10 | 75 | 25 | 7.4 | 100.7 | 6.3 | 89.1 | 99.1 |
| Comp. | n/a | n/a | n/a* | 107.1 | 1.7 | 90.5 | 99.3 |
| Ex. 1 | | | | | | | |
| Comp. | n/a | n/a | n/a* | 100.3 | 3.9 | 87.9 | 99.2 |
| Ex. 2 | | | | | | | |
| Comp. | n/a | n/a | 4.7 | 99.0 | 1.7 | 90.8 | 99.4 |
| Ex. 3 | | | | | | | |
| Comp. | n/a | n/a | 3.7 | 91.4 | 17.3 | 90.8 | 97.8 |
| Ex. 4 | | | | | | | |
| Comp. | n/a | n/a | 3.4 | 92.8 | 12.4 | 92.0 | 97.5 |
| Ex. 5 | | | | | | | |

n/a* means not able to be measured at 200° C. because of viscosity of material.

As shown by Tables 1 to 4 the molding compositions according to the invention (examples 1 to 10) create a better balance of stiffness and toughness, with higher hardness and Vicat softening temperature being achieved without a sacrifice in appearance compared to current commercial styrenic impact modified clear molding compositions. By using a rubber component (block copolymer (b)) with a specific high diene content in combination with a specific SMMA copolymer having a high MMA-content, lower amounts of the rubber component are needed, which provides an SMMA continuous phase with the rubber component (b) finely dispersed therein while maintaining high transmittance and clarity.

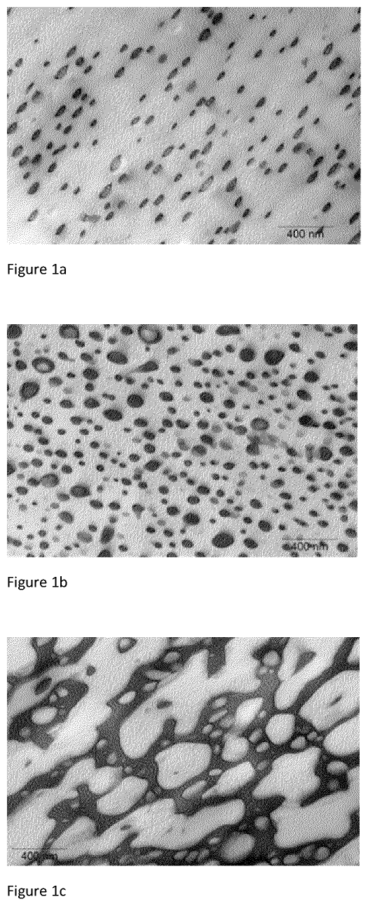

FIGS. 1a, 1b and 1c are TEM images which show the morphology of SMMA/SBS molding compositions—obtained by an extrusion molding process—which differ only in the amount of SBS rubber component (b).

FIG. 1a shows a SMMA/SBS molding composition according to the invention having a SBS rubber component content of 10 wt.-%.

FIG. 1b shows a SMMA/SBS molding composition according to the invention having a SBS rubber component content of 20 wt.-%.

FIG. 1c shows a SMMA/SBS molding composition (non-inventive) having a SBS rubber component content of 30 wt.-%.

The molding compositions according to the invention with 10 wt.-% or 20 wt.-% SBS rubber component (b) (cp. FIGS. 1a and 1b) show an SMMA continuous phase in which the SBS rubber component is finely dispersed whereas a corresponding molding composition with 30 wt.-% SBS rubber component has a changed—i.e. discontinuous—morphology for the SMMA (cp. FIG. 1c).

FIG. 1d is a TEM image which shows an impact modified SMMA copolymer according to comparative example 5 (Denka TH-21) which is made via a reactor technology by adding the rubber component to the polymerization reaction of styrene and MMA monomers.

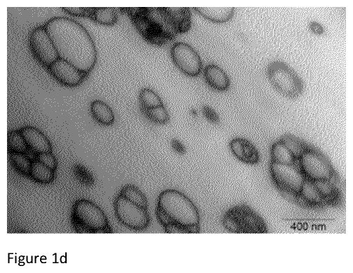

Preferred molding compositions according to the invention form a SMMA continuous phase in which the SBS rubber component (b) is dispersed which allows for better extrusion, thermal and chemical resistance, while maintaining high transmittance and clarity (cp. FIGS. 1 and 2 and Table 4).

The composition comprising a SMMA copolymer and a SBC-block copolymer as described by the invention showed high clarity and ductile properties.

TABLE 5

| | | | | | Comp. | Comp. | Comp. |
|---|---|---|---|---|---|---|---|
| | Units | Example 5 | Example 6 | Example 7 | Ex. 1 | Ex. 2 | Ex. 3 |
| [symbol] -% SBS (b) | % | 18 | 18.75 | 19 | n/a | n/a | n/a |
| MFR | g/10 min | 5.5 | 5.2 | 6.5 | n/a* | n/a* | 4.7 |
| VST | ° C. | 102.7 | 103.5 | 102.1 | 107.1 | 100.3 | 99.0 |
| Haze | % | 2.3 | 3.0 | 2.4 | 1.7 | 3.9 | 1.7 |
| Transmission | % | 91.6 | 90.8 | 91.7 | 90.5 | 87.9 | 90.8 |
| Clarity | % | 98.9 | 99.4 | 99.3 | 99.3 | 99.2 | 99.4 |
| Strain at break | % | 22 | 24 | 24 | 29 | 55 | 40 |
| Tensile strength | psi | 5600 | 5800 | 5400 | 5000 | 4500 | 4100 |
| Flexural modulus | kpsi | 300 | 305 | 290 | 245 | 230 | 260 |
| Rockwell hardness | R scale | 100 | 99 | 99 | 99 | 93 | 74 |
| Izod | ft-lb/in | 0.5 | 0.8 | 0.7 | 1.0 | 1.3 | 2.2 |
| Unnotched Izod | ft-lb/in | 13.7 | >16 (nb) | >16 (nb) | 15.6 | >16 (nb) | >16 (nb) |
| Injection molded | in-lb | 9.7 | 7.3 | 9.1 | 3.3 | 3.1 | 2.8 |
| Gardner Impact | | | | | | | |

n/a* means not able to be measured at 200° C. because of viscosity of material. [symbol]
indicates data missing or illegible when filed

As shown on Tables 1 to 4 the molding compositions of Examples 5 to 7 have the optimal loading level of the SBS rubber component (B) to achieve the best balance of properties.

Table 5 demonstrates the benefits of the molding compositions of Examples 5 to 7 compared to current commercial styrenic impact modified clear resins (see comp. Ex. 1 to 3). Compared to clear MABS products of comparative examples 1 and 2—the molding compositions of examples 5 to 7 have a higher melt flow rate, tensile strength and Gardner impact strength, while maintaining similar hardness, VST, and optical properties.

When comparing the molding compositions of Examples 5 to 7 to a current commercial MBS product of comparative example 3, the benefit in the hardness, stiffness, and Vicat is significant.

Furthermore, the molding compositions according to the invention (cp. Examples 5 to 7) obtained by melt-mixing of components (a) and (b) via extrusion exhibit superior optical properties, higher stiffness, and a higher VST compared to a molding composition prepared via polymerization of the MMA and styrene monomers in presence of a rubber component in a reactor (cp. Table 6, Comparative Examples 4 and 5).

TABLE 6

| | | | | | Comp. | Comp. |
|---|---|---|---|---|---|---|
| | Units | Example 5 | Example 6 | Example 7 | Ex 4 | Ex 5 |
| [symbol] % SBS Blended | % | 18 | 18.75 | 19 | n/a | n/a |
| MFR | g/10 min | 5.5 | 5.2 | 6.5 | 3.7 | 3.4 |
| Vicat B10 | ° C. | 102.7 | 103.5 | 102.1 | 91.4 | 92.8 |
| Haze % | % | 2.3 | 3.0 | 2.4 | 17.3 | 12.4 |
| Transmission | % | 91.6 | 90.8 | 91.7 | 90.8 | 92.0 |
| Clarity | % | 98.9 | 99.4 | 99.3 | 97.8 | 97.5 |
| Strain at break | % | 22 | 24 | 24 | 55 | 40 |
| Tensile strength | Psi | 5600 | 5800 | 5400 | 5000 | 5600 |
| Flexural modulus | Kpsi | 300 | 305 | 290 | 265 | 290 |
| Rockwell hardness | R scale | 100 | 99 | 99 | 99 | 106 |
| Izod | ft-lb/in | 0.5 | 0.8 | 0.7 | 2.1 | 1.5 |
| Unnotched Izod | ft-lb/in | 13.7 | >16 (nb) | >16 (nb) | >16 (nb) | 13.4 |
| Injection molded | in-lb | 9.7 | 7.3 | 9.1 | 182 | 163 |
| Gardner Impact | | | | | | |

[symbol]

indicates data missing or illegible when filed

1-13. (canceled)

14. A molding composition comprising components (a), (b), and (c):
(a) 71 to 90 wt.-%, based on the total weight of the molding composition, of at least one random copolymer (a) made from 44 to 64 wt.-%, based on the total weight of the copolymer (a), of at least one vinylaromatic monomer (a11), and 36 to 56 wt.-%, based on the total weight of the copolymer (a), of methyl methacrylate (a12);
(b) 10 to 29 wt.-%, based on the total weight of the molding composition, of at least one vinylaromatic-diene block copolymer (b) which comprises at least two hard blocks S made from vinylaromatic monomers and at least one soft block B made from dienes and/or at least one soft block B/S made from dienes and vinylaromatic monomers,
wherein the proportion of the diene is 47 to 67 wt.-%, based on the total weight of the block copolymer (b); and
(c) 0 to 5 wt.-%, based on the total weight of the molding composition, of one or more additive(s) and/or processing aid(s) (c);
wherein the sum of components (a), (b), and (c) adds up to 100 wt.-%.

15. The molding composition of claim 14 comprising:
75 to 88 wt.-%, based on the total weight of the molding composition, of component (a);
12 to 25 wt.-%, based on the total weight of the molding composition, of component (b); and
0 to 5 wt.-%, based on the total weight of the molding composition, of component (c).

16. The molding composition of claim 14 comprising:
73 to 80 wt.-%, based on the total weight of the molding composition, of component (a);
17 to 20 wt.-%, based on the total weight of the molding composition, of component (b); and
0 to 3 wt.-%, based on the total weight of the molding composition, of component (c).

17. The molding composition of claim 14 consisting of:
73 to 80 wt.-%, based on the total weight of the molding composition, of component (a);
17 to 20 wt.-%, based on the total weight of the molding composition, of component (b); and
0.1 to 3 wt.-%, based on the total weight of the molding composition, of component (c).

18. The molding composition of claim 14, wherein the values of the refractive index (at 589.3 nm) of components (a) and (b) differ no more than 0.01.

19. The molding composition of claim 14, wherein the at least one random copolymer (a) is made from 48 to 60 wt.-%, based on the total weight of the copolymer (a), of the vinylaromatic monomer (a11) and 40 to 52 wt.-%, based on the total weight of the copolymer (a), of the methyl methacrylate (a12).

20. The molding composition of claim 14, wherein the proportion of the diene of the vinylaromatic-diene block copolymer (b) is 52 to 62 wt.-%, based on the total weight of the block copolymer (b).

21. The molding composition of claim 14, wherein component (b) is a linear block copolymer with two terminal hard blocks S and at least one soft block B and/or at least one soft block B/S.

22. The molding composition of claim 14, wherein component (b) is a styrene-butadiene block copolymer of the structure S-B-S or S-B/S-S.

23. The molding composition of claim 14, wherein component (a) forms a continuous phase in which component (b) is finely dispersed.

24. A process for the preparation of the molding composition of claim 14, wherein component (a), component (b), and, if appropriate, component (c) are melt-mixed.

25. A shaped article produced from the molding composition of claim 14.

26. Houseware, home appliance, thermoformed packaging, and blow molded bottle applications comprising the molding composition of claim 14.

27. Houseware, home appliance, thermoformed packaging, and blow molded bottle applications comprising the shaped article of claim 25.

28. The molding composition of claim 14, wherein:
the at least one vinylaromatic monomer (a11) is styrene; and
the at least one vinylaromatic-diene block copolymer (b) comprises at least two terminal hard blocks S made from styrene and at least one soft block B made from butadiene and/or at least one soft block B/S made from butadiene and styrene.

29. The molding composition of claim 14 comprising:
78 to 85 wt.-%, based on the total weight of the molding composition, of component (a);
15 to 22 wt.-%, based on the total weight of the molding composition, of component (b); and
0 to 3 wt.-%, based on the total weight of the molding composition, of component (c).

30. The molding composition of claim 14, wherein the at least one random copolymer (a) is made from 50 to 58 wt.-%, based on the total weight of the copolymer (a), of the vinylaromatic monomer (a11), and 42 to 50 wt.-%, based on the total weight of the copolymer (a), of the methyl methacrylate (a12),
wherein the vinylaromatic monomer (a11) is styrene.

31. A process for the preparation of the molding composition of claim 14, wherein component (a), component (b), and, if appropriate, component (c) are melt-mixed by extrusion.
